(19) United States
(12) Patent Application Publication
(10) Pub. No.: US 2002/0052207 A1
(43) Pub. Date: May 2, 2002

(54) Context tags for context-aware computer programs

(76) Inventor: Jason F. Hunzinger, Carlsbad, CA (US)

Correspondence Address: SCOTT C. HARRIS, FISH & RICHARDSON P.C., Suite 500, 4350 La Jolla Village Drive, San Diego, CA, 92122, US

(21) Appl. No.: 09/765,813

(22) Filed: Jan. 19, 2001

Related U.S. Application Data
(60) Provisional application No. 60/223,463, filed on Aug. 7, 2000.

(51) Int. Cl. H04Q 7/20

(52) U.S. Cl. 455/456; 455/435

(57) ABSTRACT

A mobile station in a wireless communication system associates a plurality of context tags with corresponding reference information. The reference information may define a characteristic, such as the location of the mobile station or a time frame. The context tags assigns an easily defined term to the reference information. The mobile station may then run programs that refer to the context tags, and not specifically to the reference information.

### TECHNICAL FIELD

This invention relates to wireless communication systems, and more particularly to providing context tags to handsets in wireless communication systems.

### BACKGROUND

The desire to use information in wireless communication systems is constantly increasing. With the increased use of the wireless web on cellular telephones, the versatility and potential of the wireless communication system is increasing. For example, many cellular phones also include personal information managers (PIMs). The PIMs may be set to give reminders based on certain conditions being met, such as arriving at the office or the end of the workday. However, each of these conditions may be different for each individual. What is desired is a technique that allows each individual to define a set of conditions based upon the individuals own data, and use those conditions with their wireless telephone.

### SUMMARY

A mobile station in a wireless communication system associates a plurality of context tags with corresponding reference information. The reference information may define a characteristic, such as the location of the mobile station or a time frame. The context tags assigns an easily defined term to the reference information. The mobile station may then run programs that refer to the context tags, and not specifically to the reference information.

### DESCRIPTION OF DRAWINGS

These and other features and advantages of the invention will become more apparent upon reading the following detailed description and upon reference to the accompanying drawings.

FIG. 1 illustrates components of a wireless communication system appropriate for use with an embodiment of the invention.

FIG. 2 is a block diagram showing features of a mobile station according to one embodiment of the invention.

FIG. 3 is a table illustrating the association between a context tag and the related defining information.

FIG. 4 illustrates a process for defining the context tags according to one embodiment of the present invention.

FIG. 5 illustrates a process for using the context tags in a program according to one embodiment of the present invention.

### DETAILED DESCRIPTION

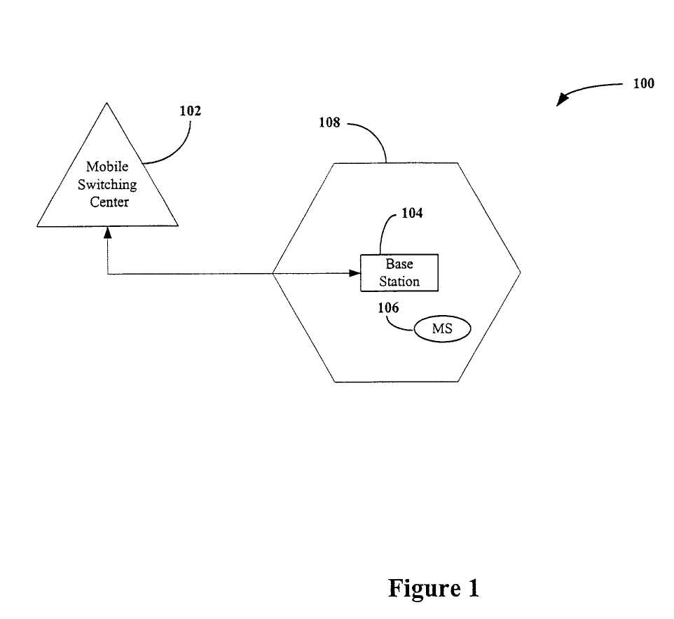

FIG. 1 illustrates components of a wireless communication system. A mobile switching center 102 communicates with a base station 104. The base station 104 broadcasts data to and receives data from mobile stations 106 within a cell 108. The cell 108 is a geographic region, roughly hexagonal, having a radius of up to 35 kilometers or possibly more.

The mobile station 106 is capable of receiving data from and transmitting data to a base station 104. Additional cells adjacent to the cell 108 permit mobile stations 106 to cross cell boundaries without interrupting communications. This is because base stations 104 in adjacent cells assume the task of transmitting and receiving data for the mobile stations 106. The mobile switching center 102 coordinates all communication to and from mobile stations 106 in a multi-cell region, thus the mobile switching center 102 may communicate with many base stations 104.

The mobile stations 106 may move about freely within the cell 108 while communicating either voice or data. The mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone synchronizes communication with the base station 104. The cellular telephone then registers with the mobile switching center 102 to make itself known as an active user within the wireless network.

The mobile station 106 scans data frames broadcast by the base station 104 to detect any telephone calls or paging messages directed to the cellular telephone. In this call detection mode, the mobile station 106 receives, stores and examines paging message data, and determines whether the data contains an identifier matching an identifier of the mobile station 106. If a match is detected, the mobile station 106 establishes a call with the mobile switching center 102 via the base station 104. If no match is detected, the mobile station 106 enters an idle state for a predetermined period of time, then exits the idle state to receive another transmission of paging message data.

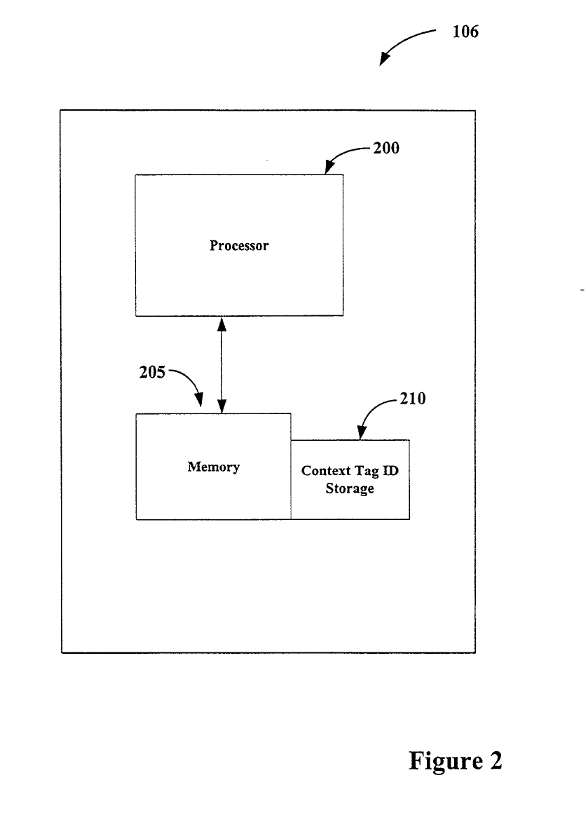

FIG. 2 shows a block diagram of the mobile station 106 and the processing that occurs in that mobile station 106. The processor 200 is driven by a program stored in a memory 205. Context tags and associated information for the mobile station 106 may also be stored in another part of memory shown here as 210. The memory 210 stores various conditions including information obtained from searches to base stations.

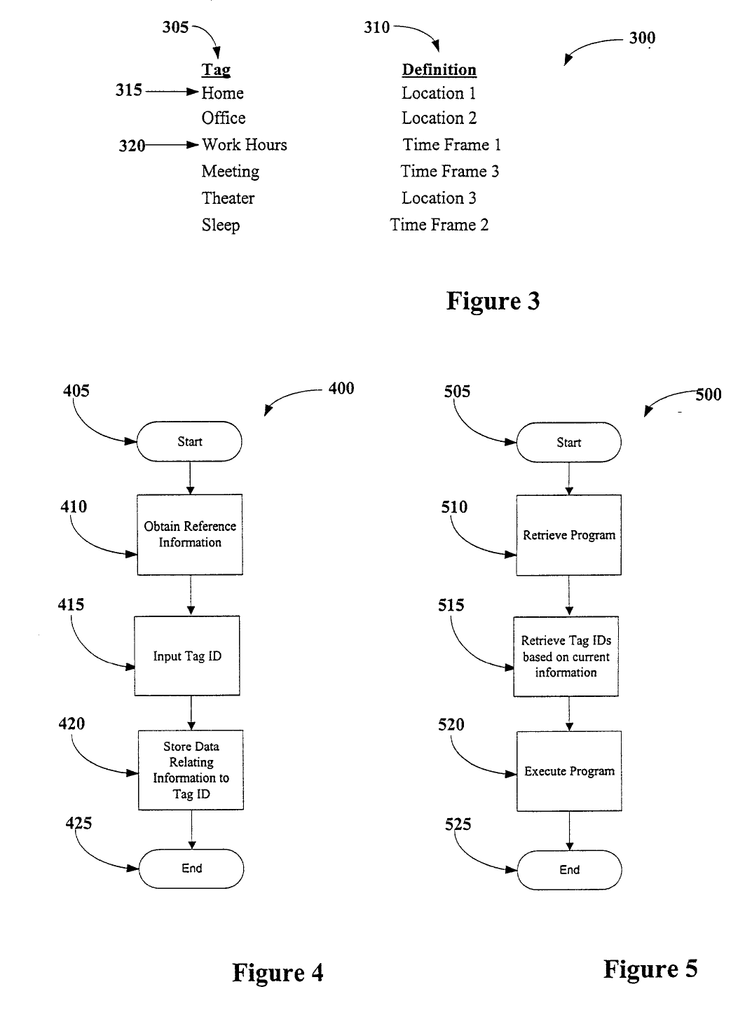

FIG. 3 is a table 300 illustrating the association between a context tag 305 and the related defining information 310. The information shown in the table 300 is stored in the memory 210 of the mobile station 106. Thus, only the mobile station 106 knows what defines each of the tags 305. The table 300 includes a plurality of tag identifications 305 and corresponding definition information 310. The context tags may define a variety of items, including but not limited to location information and time frame information.

Examples of the types of context tags are illustrated in the table 300. A location tag is shown in line 315. Here, the mobile station is at a user's house, and the current position information is saved within the mobile station. The position information may be obtained from a variety of sources, including global positioning, triangulation, current base station in use, or any other method that is known in the art. How the position information is obtained is not important for the purposed of defining the context identification. Further, the mobile station 106 does not even have to currently be at the defined position. The position information may be taken from the memory 205 or input directly by the user. However, once the position information is obtained, the user inputs the context tag “Home” to define that position information to mean the mobile is at the user's residence. The same procedure may be used to define other locations, such as “Office” or “Theater”.

An example of a time frame tag is illustrated in line 320 of table 300. A time frame, such as 9am-5pm may be input into the mobile station 106. This time frame is then assigned a context identification such as “Work Hours”.

FIG. 4 illustrates a process according to one embodiment for defining the context tags 305. The processor 200 executes a process 400 shown in FIG. 4. The process 400 begins at a START state 405. Proceeding to block 410, the mobile station 106 obtains the reference information that defines the context tag 305. As stated above, this information may include position information, time information, or any other information that helps define a state.

Proceeding to block 415, the process 400 allows for a context tag identifier 305 to be input into the mobile station 106. The tag identifier 305 may be input using the keypad of the mobile station 106, or using any other method of data entry known in the art. Preferably, the tag identifier 305 may be a common term that clearly defines a state for the user.

Proceeding to block 420, the mobile station 106 correlates the tag identifier 305 with the defining information 310. This correlated information is then stored in the memory 210 of the mobile station 106. Thus, only the mobile station knows what defines each of the context tags 305. The process then terminates in an END block 425.

FIG. 5 illustrates a process 500 according to one embodiment for using the context tags 305 of the present invention. The process 500 begins in START block 505. Proceeding to block 510, the mobile station 106 retrieves a program to run. The program may be retrieved from a wireless web browser, from the wireless service provider, or may be stored within the mobile station. The program may be loaded into the memory 205 of the mobile station 106.

Proceeding to block 515, the mobile station 106 determines what context tags 305 are included in the program, and then retrieves the appropriate context tags 305 from the memory 210 based on the current information and stored relationships. For example, if it is 2pm, the mobile station 106 will find the time frame definition including 2pm, such as 9am-5pm, and retrieve the associated context tag, such as “Work Hours.” The mobile station 106 may retrieve as many context tags 305 are necessary.

Proceeding to block 520, the stored program is then executed using the retrieved context tags 305. For example, the program may set the ringing volume and type based on the context tag 305. If a context tag 305 of “Staff Meeting” is active, the ringer may be turned off and the vibrate mode activated. Conversely, for an “Outdoor” context tag 305, the ringer may be set to high. Other context tags 305 may also be used by the program to cause other actions to occur.

It can be appreciated that the program does not need to know the data that defines the context tag, thus enhancing the privacy for the user. For example, a user may work nights and defines his work hours as 1am-10am. When a program executes during work hours, the program may simply query the mobile station 106 to determine if the “Work Hours” context tag is currently true. The program may never know what is the exact definition of the “Work Hours” context tag, thus enhancing the privacy for the user.

Numerous variations and modifications of the invention will become readily apparent to those skilled in the art. Accordingly, the invention may be embodied in other specific forms without departing from its spirit or essential characteristics.

What is claimed is:

1. A method of defining contextual information comprising:
obtaining reference information;
assigning an identifier tag to the reference information; and
storing the reference information correlating with the identifier tag.

2. The method of claim 1, further comprising executing a program using the stored identifier tag.

3. The method of claim 1, further comprising storing the correlated information in a mobile station.

4. The method of claim 1, further comprising defining a context tag based on location data.

5. The method of claim 1, further comprising defining a context tag based on time frame data.

6. The method of claim 2, further comprising retrieving all context tags referred to within the program.

7. The method of claim 2, further comprising storing the correlated reference information and identifier tag in a first location and executing the program in a second location, wherein the second location does not obtain the reference information.

8. The method of claim 7, further comprising the first location informing the second location of a state of the identifier tag.

9. A mobile station for use in a wireless communication system comprising:
a memory which stores a plurality of context tags and associated defining characteristics; and
a processor which executes programs based on the context tags which meet the current conditions.

10. The mobile station of claim 9, wherein the defining characteristics are location based.

11. The mobile station of claim 9, wherein the defining characteristics are time frame based.

12. The mobile station of claim 9, wherein the programs are obtained from memory.

13. The mobile station of claim 9, wherein the programs are obtained from the wireless web.

14. The mobile station of claim 9, wherein the programs do not have access to the defining characteristics of the context tags.

15. The mobile station of claim 9, wherein the memory informs the processor of the state of the context tags.
